(19) United States
(12) Patent Application Publication
(10) Pub. No.: US 2022/0363096 A1
(43) Pub. Date: Nov. 17, 2022

(54) WEIGHT MEASURING HITCH BALL ASSEMBLY INCLUDING LOW PROFILE HITCH BALL ASSEMBLIES FOR MEASURING WEIGHT OF A TRAILER SUPPORTED BY A TOW VEHICLE

(71) Applicant: Weigh Safe, LLC, Lindon, UT (US)

(72) Inventors: Bryce Doman, Alpine, UT (US); Brandon Doman, Pleasant Grove, UT (US); Morgan McAllister, Lindon, UT (US)

(73) Assignee: Weigh Safe, LLC, Lindon, UT (US)

(21) Appl. No.: 17/745,707

(22) Filed: May 16, 2022

Related U.S. Application Data
(60) Provisional application No. 63/188,889, filed on May 14, 2021.

(51) Int. Cl. B60D 1/24; B60D 1/06; G01G 19/12

(52) U.S. Cl. CPC B60D 1/248; B60D 1/065; G01G 19/12

(57) ABSTRACT

A weight measuring hitch ball assembly is described. The assembly can include a hitch ball having a ball and a lower portion. The assembly can also include a body portion defining a hitch ball opening that slidably receives the lower portion of the hitch ball. The assembly can further include a load measurement device operably associated with the body portion and the hitch ball to determine a magnitude of a force acting on the hitch ball. Additionally, the assembly can include a hitch mount interface configured to interface with an attachment structure that facilitates coupling the weight measuring hitch ball assembly to a tow vehicle.

### PRIORITY DATA

This application claims the benefit of U.S. Provisional Patent Application Ser. No. 63/188,889, filed on May 14, 2021, which is incorporated by reference.

### FIELD

The disclosed embodiments relate generally to trailer hitch devices, systems, and associated methods. More specifically, the disclosed embodiments relate to hitch ball assemblies including weight measuring devices for measuring weight of a trailer supported by a tow vehicle.

### BACKGROUND

When towing a trailer behind a vehicle, one factor that can significantly affect safety is the hitch or tongue weight (i.e., static downward force) that the trailer applies to the hitch of the tow vehicle. If the hitch or tongue of the trailer does not apply enough downward force to the tow vehicle hitch, a dangerous condition called trailer sway could result. If the hitch or tongue of the trailer applies too much downward force to the tow vehicle hitch, then the rear tires of the tow vehicle can be overloaded, thus pushing the rear of the vehicle around and compromising steering and/or braking of the tow vehicle. A generally acceptable tongue weight for a “bumper pull” trailer is somewhere between 9% and 15% of the gross trailer weight (GTW), and a generally acceptable hitch weight for a “bed mount” (e.g., gooseneck) trailer is somewhere between 15% and 25% of the GTW.

### SUMMARY

Weight measuring hitch ball assemblies are provided. In one embodiment, a weight measuring hitch ball assembly can include a hitch ball having a ball and a lower portion. The assembly can also include a body portion defining a hitch ball opening that slidably receives the lower portion of the hitch ball. The assembly can further include a load measurement device operably associated with the body portion and the hitch ball to determine a magnitude of a force acting on the hitch ball. Additionally, the assembly can include a hitch mount interface configured to interface with an attachment structure that facilitates coupling the weight measuring hitch ball assembly to a tow vehicle.

In other embodiments, there are provided weight measuring hitch ball systems. In still other embodiments, there are provided methods of measuring weight of a trailer supported by a tow vehicle.

### BRIEF DESCRIPTION OF THE DRAWINGS

FIG. 1 illustrates a trailer hitch system for measuring a hitch weight of a trailer, in accordance with an example of the present disclosure.

FIG. 2 illustrates a weight measuring hitch ball assembly of the trailer hitch system of FIG. 1, in accordance with an example of the present disclosure.

FIGS. 3A and 3B illustrate a weight measuring hitch ball assembly in accordance with an example of the present disclosure.

FIGS. 3C-3E illustrate a weight measuring hitch ball system in which the weight measuring ball mount assembly of FIGS. 3A and 3B is incorporated, in accordance with an example of the present disclosure.

FIG. 3F illustrates a weight measuring hitch ball system in which the weight measuring ball mount assembly of FIGS. 3A and 3B is incorporated, in accordance with an example of the present disclosure.

FIG. 3G illustrates a weight measuring hitch ball system in which the weight measuring ball mount assembly of FIGS. 3A and 3B is incorporated, in accordance with an example of the present disclosure.
FIG. 4A illustrate a weight measuring hitch ball assembly in accordance with an example of the present disclosure.

FIG. 4B is a side cross-sectional view of the weight measuring hitch ball assembly of FIG. 4A.

FIG. 4C is a top cross-sectional view of the weight measuring hitch ball assembly of FIG. 4A.

FIG. 5A illustrate a weight measuring hitch ball assembly in accordance with an example of the present disclosure.

FIGS. 5B and 5C are side cross-sectional views of the weight measuring hitch ball assembly of FIG. 5A. FIG. 6A is an isometric view of a weight measuring hitch ball assembly having a low profile in accordance with an example embodiment. FIG. 6B is a side view of the weight measuring hitch ball assembly of FIG. 6A. FIG. 6C is a front view of the weight measuring hitch ball assembly of FIG. 6A, and FIG. 6D is a section view of the weight measuring hitch ball assembly taken along the lines A-A.

FIG. 6E is a front view of a hitch ball of the weight measuring hitch ball assembly of FIG. 6A, and FIG. 6F is a section view of the hitch ball of FIG. 6E taken along the line B-B.

FIG. 6G is a rear view of a body portion of the weight measuring hitch ball assembly of FIG. 6A, and FIG. 6H is an isometric view of the body portion of the weight measuring hitch ball assembly of FIG. 6A.

FIG. 6I is a side view of the weight measuring hitch ball assembly of FIG. 6A, and FIG. 6J is a section view of the weight measuring hitch ball assembly taken along the line D-D in FIG. 61. FIG. 6K is a front view of the weight measuring hitch ball assembly of FIG. 6A, and FIG. 6L is a section view taken along the line C-C of FIG. 6K.

FIG. 7A is a front view of a weight measuring hitch ball assembly having a low profile in accordance with an example embodiment, and FIG. 7B is a section view of the weight measuring hitch ball assembly taken along the line E-E.

FIG. 7C is an isometric view of a hitch ball of the weight measuring hitch ball assembly of FIG. 7A, FIG. 7D is a front view of a body portion of the weight measuring hitch ball assembly of FIG. 7C, FIG. 7E is a section view of the body portion taken along the line F-F of FIG. 7D, and FIG. 7F is an isometric view of the body portion of FIG. 7D.

FIG. 8A is an isometric view of a weight measuring hitch ball assembly having a low profile in accordance with an example of the present disclosure, FIG. 8B is a front view of a hitch ball of the weight measuring hitch ball assembly of FIG. 8A, and FIG. 8C is a section view of the hitch ball of FIG. 8A taken along the line G-G.

FIG. 8D is a front view of the weight measuring hitch ball assembly of FIG. 8A, and FIG. 8E is a section view of the weight measuring hitch ball assembly of FIG. 8D taken along the line H-H.

FIG. 9A is a front view of a weight measuring hitch ball assembly, FIG. 9B is a section view of the weight measuring hitch ball assembly of FIG. 9A taken along the line J-J, and FIG. 9C is an isometric view of a hitch ball of the weight measuring hitch ball assembly of FIG. 9A.

### DETAILED DESCRIPTION OF EMBODIMENTS

Definitions

In describing and claiming the present invention, the following terminology will be used in accordance with the definitions set forth below.

The singular forms “a,” “an,” and, “the” include plural referents unless the context clearly dictates otherwise.

As used herein, the term “about” is used to provide flexibility to a numerical range endpoint by providing that a given value may be “a little above” or “a little below” the endpoint.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term, like “comprising” or “including,” it is understood that direct support should also be afforded to “consisting essentially of” language as well as “consisting of”language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects or structures described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

U.S. Provisional Patent Application Ser. Nos. 62/249,730 filed on Nov. 2, 2015, 62/325,607 filed on Apr. 20, 2016, 61/826,247 filed on May 22, 2013, 61/928,166 filed on Jan. 16, 2014, 61/948,487 filed on Mar. 5, 2014, and 61/948,456 filed Mar. 5, 2014, are each incorporated herein by reference.

U.S. Patent Application Ser. Nos. 14/639,987 filed on Mar. 5, 2015, 14/639,987 filed on Mar. 5, 2015, and 14/284,273 filed on May 21, 2014, are each incorporated herein by reference.

PCT Application Serial No. PCT/US16/21266 filed on Mar. 7, 2016, is incorporated herein by reference.

Description

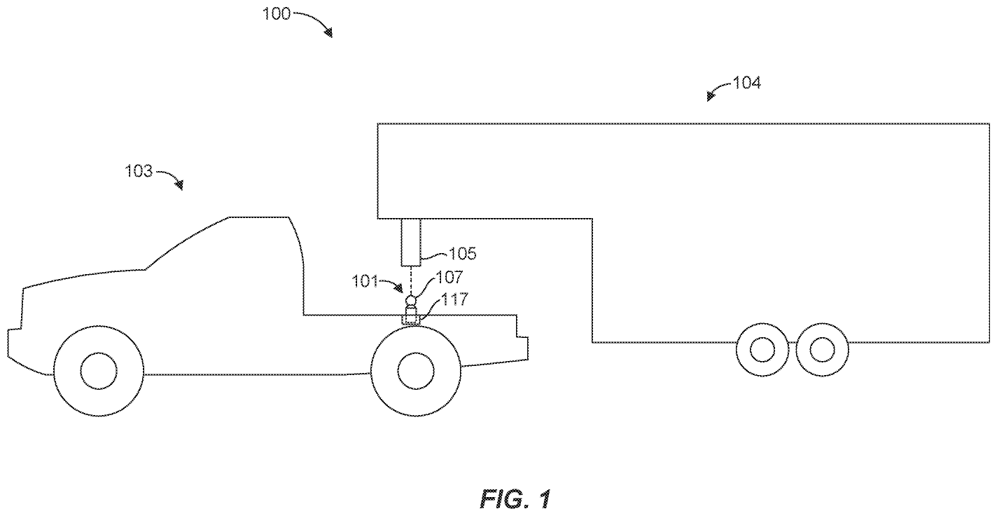

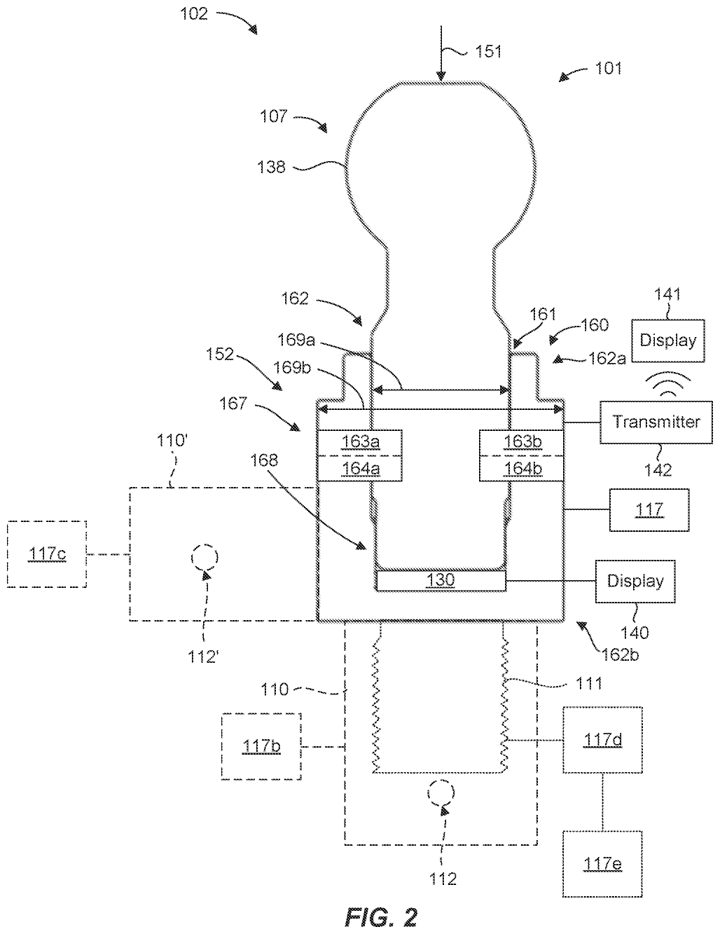

With reference to FIG. 1, illustrated is a trailer hitch system 100 for measuring hitch weight (e.g., ball weight, pin weight, or tongue weight) of a trailer, in accordance with an example of the present disclosure. In general, the trailer hitch system 100 can include a weight measuring hitch ball assembly 101 associated with a tow vehicle 103, and a trailer 104 operable to couple to the tow vehicle 103. A schematic illustration of the weight measuring hitch ball assembly 101 is shown in FIG. 2.

The weight measuring hitch ball assembly 101 can be included in a weight measuring hitch ball system 102, which can also include an attachment structure 117 that facilitates coupling the weight measuring hitch ball assembly 101 to the tow vehicle 103 (FIG. 1). Attachment structures are discussed in more detail below. The weight measuring hitch ball assembly 101 can include a hitch ball 107 (e.g., a goose ball, a ball mount, etc.) configured to engage with a coupling device 105 (FIG. 1) of the trailer 104 (e.g., a gooseneck, a tongue, etc.), and a load measurement device 130 (FIG. 2) operable to determine a magnitude of a downward force 151 acting on the hitch ball 107.

Although the trailer hitch system 100 includes what is generally referred to as a “hitch ball” throughout the present disclosure for coupling with a trailer, it should be recognized that the trailer hitch system can include any suitable form of coupling with a trailer, such as a lunette ring and pintle hook. Aspects of the present disclosure that facilitate measuring hitch weight of a trailer as disclosed herein can be incorporated into such coupling arrangements.

The weight measuring hitch ball assembly 101 can also include a support structure or body portion 160. The hitch ball 107 can include a ball 138 and a lower portion 162. The ball 138 can be configured to interface with a coupling device of a trailer (e.g., a trailer tongue, gooseneck, etc.). The ball 138 and the lower portion 162 can be separate and distinct structures coupled to one another (i.e., rigidly and fixedly coupled) or the ball 138 and the lower portion 162 can form a single, monolithic structure. In either case, the hitch ball 107 can be a single structure comprised of multiple component parts or portions that remain in a fixed relationship to one another.

The load measurement device 130 can be operably associated with the body portion 160 and the hitch ball 107 to determine a magnitude of the force 151 acting on the hitch ball 107 (e.g., through the trailer interface with the ball 138). For example, the body portion 160 can include or define a hitch ball opening or socket 161 to slidably receive the lower portion 162 of the hitch ball 107. The hitch ball opening 161 can be configured to constrain translational movement of the hitch ball 107 to a single degree of freedom (i.e., parallel to the downward force 151), which can facilitate the hitch ball 107 exerting a force on the load measurement device 130.

The load measurement device 130 can comprise any suitable type of load measurement device or mechanism described herein. For example, the load measurement device 130 can comprise a load cell or transducer, such as a strain gage load cell, a mechanical load cell, a hydraulic load cell, and/or a pneumatic load cell, or any other suitable type of force and/or pressure sensor. In some examples, the load measurement device 130 can comprise a force gauge, such as a spring scale. In some embodiments, the load measurement device 130 can include a piston, a hydraulic medium (e.g., a fluid), and a pressure sensor or a load gauge as described in several examples hereinabove and hereinbelow. For instance, as described in other examples disclosed herein, the load measurement device 130 can include a fluid reservoir in fluid communication with a load gauge, and the fluid reservoir can comprise at least one of a hydraulic fluid or a pneumatic fluid. In one aspect, the lower portion of the hitch ball can act against a separate piston, which in turn acts on the fluid in the fluid reservoir as a means to determine the downward force 151 acting on the hitch ball. In another aspect, a bottom 168 of the lower portion 162 of the hitch ball 107 can form a piston operable to act on fluid in the fluid reservoir. In this case, the hitch ball may act directly on the fluid in the fluid reservoir, with no intermediate structures between the hitch ball and the fluid. Thus, the hitch ball 107 may be configured with an integrally formed piston to act on the fluid. In one aspect, the body portion 160 can define various features of the load measurement device 130 in addition to interfacing with and supporting the hitch ball 107. For example, the body portion 160 can form or define, at least in part, a fluid reservoir of the load measurement device 130.

In addition, the weight measuring hitch ball assembly 101 can include a display 140 for displaying or otherwise indicating force or load information obtained by the load measurement device 130. For example, the display 140 can be configured to indicate the magnitude of the downward force, as determined by the load measurement device 130. Thus, the display 140 can be an analog and/or digital display of a sensor or load cell (e.g., a pressure gauge) located local to the load measurement device 130 and/or a separate display device distinct from the load measurement device 130 (e.g., a remote display associated with the tow vehicle and/or a mobile electronic device). The display 140 can be wired and/or wirelessly connected to the load measurement device 130. Thus, in one example, the weight measuring hitch ball assembly 101 can include a wireless transmitter 142, as described herein, to wirelessly transmit force measurements to a remote display.

In one aspect, the display 140 can be associated with the body portion 160, as shown in FIG. 2. The display 140 can be any suitable type of display, such as an analog or a digital display. The display 140 can be coupled to the load measurement device 130 in any suitable manner such that the display can properly indicate the magnitude of the load on the hitch ball 107. In one aspect, the display can be mechanically, electrically, hydraulically, and/or pneumatically coupled to the load measurement device 130. The load measurement device 130 and/or the display 140 can therefore include any suitable mechanical, electrical, hydraulic, and/or pneumatic device or mechanism that can facilitate the determination and/or display of the magnitude of the load on the hitch ball 107. For example, the load measurement device 130 and/or the display 140 can include a processor and/or memory to determine the magnitude of the load on the hitch ball 107. In one aspect, a mobile device, such as a smartphone or a tablet, can include a processor and/or memory used to determine the magnitude of the load on the hitch ball 107, such as by executing an application. In another aspect, the display 140 can be calibrated to indicate the magnitude of the load on the hitch ball 107, based on mechanical, electrical, hydraulic, and/or pneumatic input from the load measurement device 130. In a particular aspect, therefore, the display 140 can be integral with the load measurement device 130 in determining the magnitude of the load on the hitch ball 107.

In some examples, the weight measuring hitch ball assembly 101 can include a transmitter 142 such that load data pertaining to the magnitude of the downward force on the hitch ball 107 can be wired or wirelessly transmitted to the display 140. In one aspect, the transmitter can transmit load data to a location remote from the ball hitch, such as to a remote display 141. For example, the display 141 can be located inside the vehicle and can receive load data for display to the driver or operator of the vehicle. The transmission of load data can be via vehicle wiring, such as the taillight wiring, which can be utilized to communicate load data via a signal to the interior of the vehicle. In another aspect, a wireless transmission of load data can be accomplished via a Bluetooth connection, a cellular network, LAN, WIFI, an RF signal, an infrared signal, or any other suitable type of wireless network, connection, and/or protocol. In one aspect, the display 141 can comprise a screen of a mobile device, such as a smartphone or a tablet. Thus, the load data can be communicated to any suitable location, in or out of the vehicle. It should therefore be recognized that the display 140, 141 can be disposed in any suitable location and can be in communication with the load measurement device 130 via any suitable means. In one aspect, the load measurement device 130, the display 140, and/or the transmitter 142, or any other related item or device, such as a processor, memory, a battery, or a RF receiver, can be located in or on the weight measuring hitch ball assembly 101.

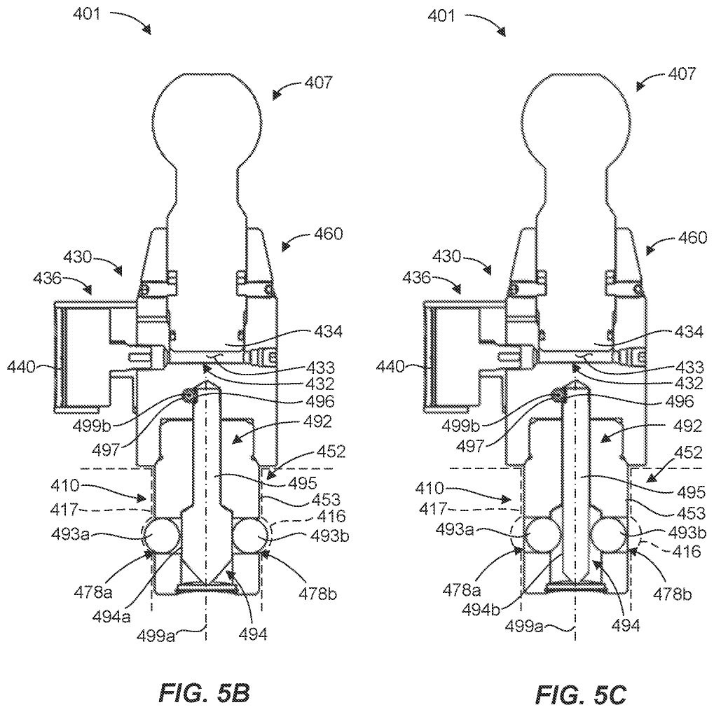

In one aspect, the weight measuring hitch ball assembly 101 of FIG. 2 can be configured to capture the hitch ball 107 to prevent the hitch ball from unwanted separation from the body portion 160. For example, the assembly 101 can include a retention coupling 167 that secures the hitch ball 107 to the body portion 160 while also facilitating slidable movement of the hitch ball 107 within the hitch ball opening 161 to determine the magnitude of the force 151 acting on the hitch ball 107. The retention coupling 167 can have one or more retention recesses 163a-b and one or more retention protrusions 164a-b, which are schematically represented in FIG. 2. The one or more retention recesses 163a-b can be associated with the hitch ball 107 (e.g., formed within the lower portion 162 of the hitch ball 107) and/or associated with the body portion 160 (e.g., formed within the body portion 160). The one or more retention protrusions 164a-b can also be associated with the hitch ball 107 (e.g., coupled to the lower portion 162 of the hitch ball 107) and/or associated with the body portion 160 (e.g., coupled to the body portion 160). Each of the retention recesses 163a-b can receive at least one of the retention protrusions 164a-b to secure the hitch ball 107 to the body portion 160. For example, the retention protrusions 164a-b can extend into the respective retention recesses 163a-b. The retention recesses 163a-b and the retention protrusions 164a-b can be configured to facilitate movement of the hitch ball 107 against the load measurement device 130 in response to the downward force 151 on the hitch ball. For example, an upper clearance between the retention protrusions 164a-b and the retention recesses 163a-b can be sized equal to or greater than a range of motion of the load measurement device 130 (e.g., maximum deflection or piston travel) in response to a maximum allowable force 151 applied to the hitch ball 107. This can ensure that the retention protrusions 164a-b will not hinder downward movement of the hitch ball 107, which could interfere with a proper measurement of the downward force 151 on the hitch ball 107. The shapes and/or sizes of the retention protrusions 164a-b and the retention recesses 163a-b can be of any suitable configuration (e.g., cross-sectional shapes that are circular, oval, elliptical, rectangular, etc.), structure (e.g., a notch, a groove, a channel, a hole, etc.), or dimension. For example, the retention protrusions 164a-b can comprise at least one of a pin, a bolt, a screw, a rod, a shaft, a tab, a flange, or a ball. In addition, the retention recesses 163a-b and the retention protrusions 164a-b can be included in any suitable quantity and in any suitable location or pattern. In one example, the retention protrusions 164a-b and the retention recesses 163a-b can include similar features (e.g., a ball and opening) found in the securing mechanism shown in FIGS. 5B and 5C and described below.

In one aspect, ends of the retention protrusions 164a-b can terminate within the retention recesses 163a-b (e.g., within the lower portion 162 of the hitch ball 107 or within the body portion 160). In other words, the retention protrusions 164a-b do not extend all the way through the hitch ball 107 (e.g., through the lower portion 162) or the body portion 160, as applicable. In a particular aspect, one or more of the retention recesses 163a-b can be blind openings or holes (e.g., openings or holes that do not extend all the way through the lower portion 162 of the hitch ball 107 or the body portion 160). Thus, one or more of the retention recesses 163a-b can be blind openings or through openings and the retention protrusions 164a-b may not extend all the way through the hitch ball 107 or body portion 160.

In one aspect, the lower portion 162 of the hitch ball 107 and the body portion 160 can have a dimensional relationship that results in a relatively “thin-walled” body portion 160 forming the hitch ball opening 161 and surrounding the lower portion 162 of the hitch ball 107. Thus, in some examples, an outer dimension 169a of the lower portion 162 of the hitch ball 107 can be greater than or equal to 50% of an outer dimension 169b of the body portion 160 about the lower portion 162 of the hitch ball 107.

The weight measuring hitch ball assembly 101 can be adapted to serve as a hitch ball or ball mount for a variety of different hitch configurations. For example, as illustrated in FIG. 2, the attachment structure 117a can be a part of or comprise an above-bed attachment structure (e.g., an above-bed gooseneck hitch system). In another example, the attachment structure 117b can be any typical vertically-oriented hitch receiver, such as a square hitch receiver (typically aftermarket) or a round hitch receiver (typically OEM) for receiving bed-mount style hitches (e.g., gooseneck hitches). In yet another example, the attachment structure 117c can be any typical horizontally-oriented hitch receiver, such as a standard 2½″, 2″, or 1¼″ size square hitch receiver for receiving hitch components (e.g., drawbars) for “bumper pull” style hitches. In another example, the attachment structure 117d can be or include a hitch or hitch portion (e.g., a drawbar) configured to interface with another attachment structure 117e (e.g., a hitch receiver) integrated with or otherwise attached to a tow vehicle. In one aspect, an attachment structure as disclosed herein can be a portion of the tow vehicle 103, such that the assembly 101 is coupled directly to the tow vehicle 103.

Accordingly, the weight measuring hitch ball assembly 101 can include a hitch mount interface 152 configured to interface with an attachment structure as disclosed herein. In one example, the hitch mount interface 152 can be at least partially defined by the body portion 160. In this case, the body portion 160 can be configured to interface directly with the attachment structure 117a. In addition, the hitch mount interface 152 can facilitate coupling with the attachment structure 117a, which can be a part of or comprise an above-bed attachment structure (e.g., an above-bed gooseneck hitch system). The hitch mount interface 152 can be located at any suitable location or position on or about the body portion 160. In one aspect, the hitch mount interface 152 can be located at an upper end 166a of the body portion 160, a lower end 166b of the body portion 160, or both.

In one aspect, the weight measuring hitch ball assembly 101 can include a hitch portion extending from the body portion. The hitch mount interface 152 can be at least partially defined by the hitch portion. Thus, the hitch portion can be configured to interface with an attachment structure as disclosed herein. In one example, a hitch portion 110 can extend downward from the body portion 160 below the hitch ball 107. In this case, the attachment structure 117b can comprise a goose ball receiver socket mounted on or otherwise associated with a tow vehicle. In another example, a hitch portion 110′ can extend laterally from the body portion 160 on a lateral side of the hitch ball 107. In this case, the attachment structure 117c can comprise a hitch receiver. In the above examples, the hitch portions 110, 110′ can be permanently attached (e.g., integrally formed) with the body portion 160 or removably coupled to the body portion 160.

The hitch mount interface 152 can be or include any suitable geometry or configuration to facilitate interfacing, coupling, joining, mating, etc. with a given attachment structure. For example, the hitch mount interface 152 can comprise at least one of a planar interface surface or a curved interface surface. In some examples, a planar interface surface can at least partially define a rectangular profile. In some examples, a curved interface surface can at least partially define a circular profile. These aspects of the hitch mount interface 152 are discussed in more detail below.

In one aspect, the hitch mount interface 152 can comprise one or more coupling features operable to facilitate securing the weight measuring hitch ball assembly 101 to a given attachment structure. Such a coupling feature can be or include any suitable coupling configuration known in the art, such as a threaded coupling feature (e.g., external threads or internal threads), a shaft, a rod, a hole, a recess, a groove, a pin, or any other feature suitable for coupling the assembly 101 to an attachment structure and/or a tow vehicle and maintaining structural integrity during towing. In one aspect, a coupling feature as disclosed herein can be associated with the body portion 160 and/or be at least partially defined by the body portion (e.g., an opening, a hole, a stud, etc.). In another aspect, a coupling feature can be associated with a hitch portion. In one example, the hitch portions 110, 110′ can include coupling features 112, 112′ (e.g., openings, holes, or other suitable features) to facilitate securing the weight measuring hitch ball assembly 101 to the respective attachment structures 117b, 117c. In a particular example, the openings 112, 112′ can be operable to receive a pin, rod, or threaded fastener, which can extend through the openings 112, 112′ of the assembly 101 and through holes of the respective attachment structures 117b, 117c. In another example, a coupling feature 111 can be operable to couple the ball mount assembly 101 to the attachment structure 117d. In one aspect, the coupling feature 111 can extend downward from the body portion 160 below the hitch ball 107, although any other suitable location and/or orientation of the coupling feature 111 is contemplated. In a particular example, the coupling feature 111 can comprise a threaded coupling feature that extends downward from the body portion 160 below the hitch ball 107. In this case the attachment structure 117d can comprise a hitch or hitch portion (e.g., a draw bar) that can couple with another attachment structure 117e (e.g., hitch receiver) that is associated with a tow vehicle.

One benefit of the coupling feature 111 is that it enables the weight measuring hitch ball assembly 101 to be removably coupled to a given attachment structure 117 (e.g., a hitch or hitch portion, drawbar, hitch receiver, etc.) that is operable to facilitate coupling the assembly 101 to the tow vehicle 103. As will be apparent to one skilled in the art, coupling devices of trailers (e.g., goosenecks, trailer tongues, etc.) have a variety of sizes and can require differing hitch ball sizes to securely couple a trailer to a towing vehicle. Some standard hitch ball sizes can include 1 ⅞″, 2″, 2 5/16″, and 3″ diameters. Thus, an assembly 101 having a suitable ball 138 size can be selected for coupling with a given structure 117 (e.g., a hitch or hitch portion, drawbar, hitch receiver, etc.) to accommodate a given size/configuration of trailer coupling device.

A method of measuring weight of a trailer supported by a tow vehicle can comprise engaging a coupling device of a trailer (e.g., a tongue or a gooseneck) with a weight measuring ball mount assembly as disclosed herein (e.g., the weight measuring ball mount assembly 101), with the weight measuring ball mount assembly being operably coupled to a tow vehicle, such as by an attachment structure associated with the tow vehicle.

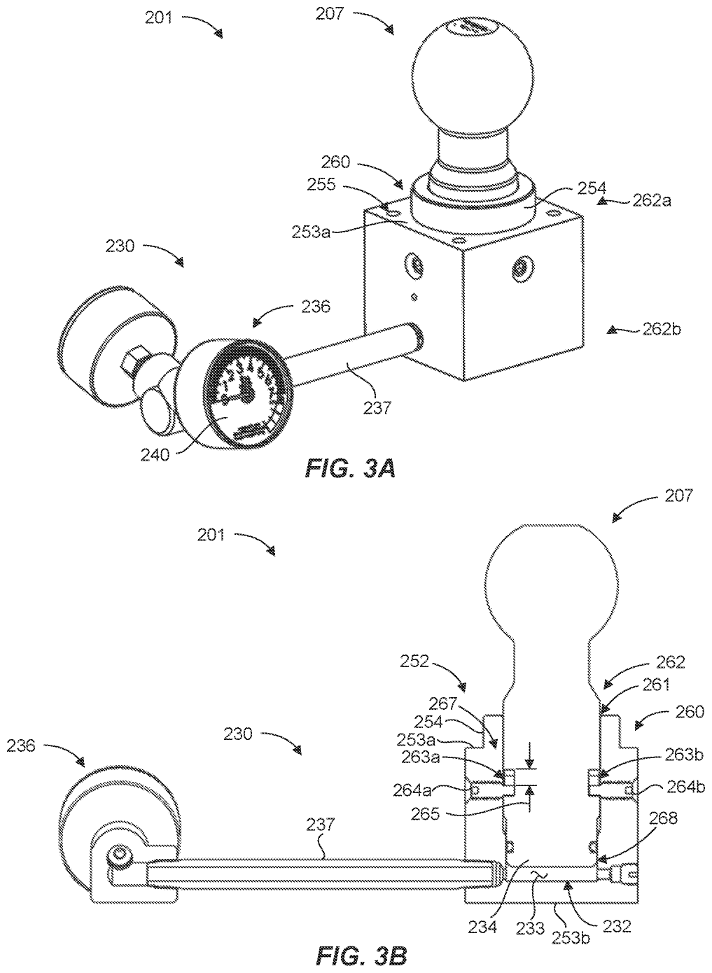

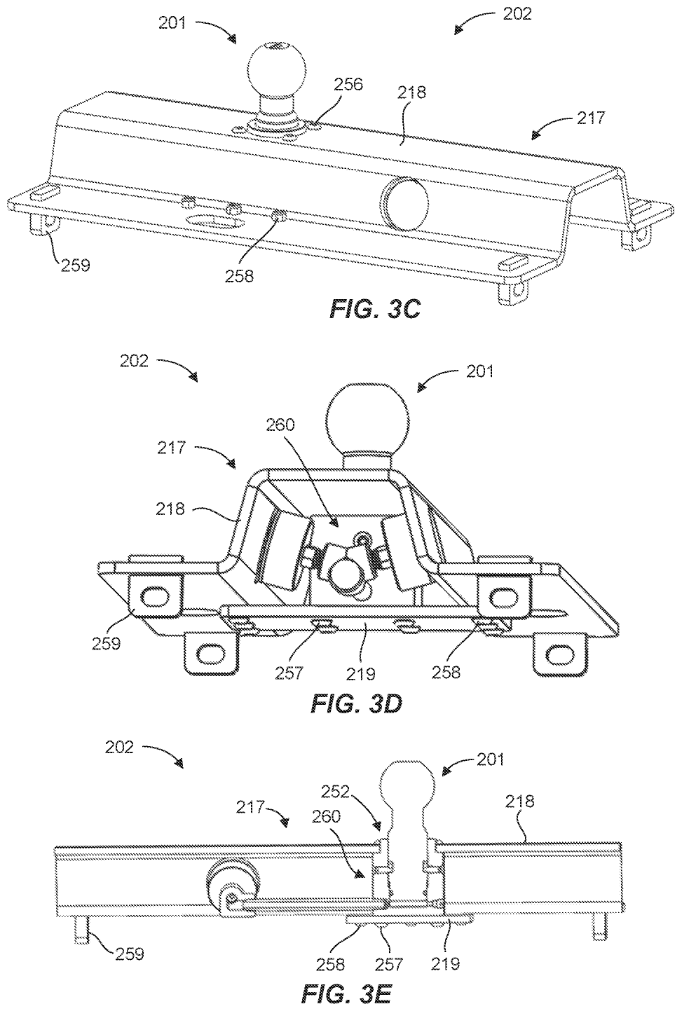

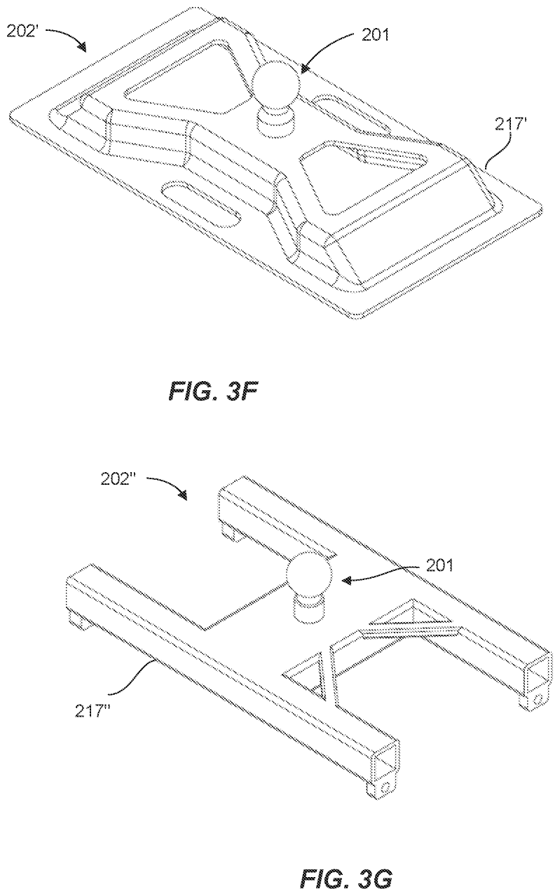

The weight measuring hitch ball assembly 101 of FIG. 2 has been shown and described as a generic representation of such an assembly. FIGS. 3A-5C include illustrations of various weight measuring hitch ball assemblies that are more specific examples of the generic weight measuring hitch ball assembly 101 of FIG. 2. Thus, the description of the weight measuring hitch ball assembly 101 in FIG. 2 may describe aspects of the various assemblies of FIGS. 3A-5C, as applicable, which may not be described with particular reference to FIGS. 3A-5C. Furthermore, certain specific aspects and features described in one example may be present in another example, although not specifically discussed with reference to that example.

FIGS. 3A and 3B illustrate a weight measuring hitch ball assembly 201 in accordance with an example of the present disclosure. In this example, a load measurement device 230 is illustrated as including a reservoir 232 having a fluid 233 and a piston 234 disposed therein, as shown in FIG. 3B. In this case, the piston 234 is integrally formed with a hitch ball 207 (e.g., a bottom 268 of a lower end 262 of the hitch ball 207 forms the piston 234). The piston 234 can affect a pressure of the fluid 233 as a result of a downward force on the hitch ball 207. The load measurement device 230 also includes a pressure sensor 236, or gauge, in fluid communication with the reservoir 232, such as via a conduit 237, to indicate a quantity of the downward force acting on the hitch ball 207 based on the pressure of the fluid. The pressure sensor 236 can be calibrated to indicate the force acting on the hitch ball 207. Although a particular load measurement device configuration is illustrated, it should be recognized that any suitable load measurement device disclosed herein can be utilized.

In one aspect, a display 240 for the pressure sensor or gauge can be included to indicate the magnitude of the load or downward force acting on the hitch ball 207. Such a display can be located proximate the pressure sensor 236 or included with a gauge. It should be recognized that a pressure sensor, a gauge, or a display can be disposed in any suitable location. For example, as shown in FIGS. 3A and 3B, the pressure sensor 236 and associated display 240 can be located at a distance from the body portion 260. In this case, the pressure sensor 236 can be in fluid communication with the fluid reservoir via the conduit 237 external to the body portion 260. In one aspect, multiple pressure sensors and/or displays can be utilized to present force information in various directions and/or locations.

The weight measuring hitch ball assembly 201 can be configured to capture the hitch ball 207 to prevent the hitch ball from unwanted separation from the body portion 260. For example, as shown in FIG. 3B, the weight measuring hitch ball assembly 201 can include a retention coupling 267 that secures the hitch ball 207 to the body portion 260 while also facilitating slidable movement of the hitch ball 207 within a hitch ball opening 261 of the body portion 260 to determine the magnitude of a force acting on the hitch ball 207.

In the illustrated example, the retention coupling 267 can have one or more retention recesses 263a-b associated with the hitch ball 207 (e.g., formed within the lower portion 262 of the hitch ball 207). The retention coupling 267 can also have one or more retention protrusions 264a-b associated with the body portion 260 (e.g., coupled to the body portion 260). Each of the retention recesses 263a-b can receive at least one of the retention protrusions 264a-b to secure the hitch ball 207 to the body portion 260. For example, the retention protrusions 264a-b can extend into the respective retention recesses 263a-b. The retention recesses 263a-b and the retention protrusions 264a-b can be configured to facilitate movement of the hitch ball 207 against the load measurement device 230 in response to the downward force 251 on the hitch ball. For example, an upper clearance 265 between the retention protrusions 264a-b and the retention recesses 263a-b can be sized equal to or greater than a range of motion of the load measurement device 230 (e.g., maximum deflection or piston travel) in response to a maximum allowable force 251 applied to the hitch ball 207. This can ensure that the retention protrusions 264a-b will not hinder downward movement of the hitch ball 207, which could interfere with a proper measurement of the downward force 251 on the hitch ball 207. The shapes and/or sizes of the retention protrusions 264a-b and the retention recesses 263a-b can be of any suitable configuration (e.g., cross-sectional shapes that are circular, oval, elliptical, rectangular, etc.), structure (e.g., a notch, a groove, a channel, a hole, etc.), or dimension. For example, the retention protrusions 264a-b can comprise at least one of a pin, a bolt, a screw, a rod, a shaft, a tab, a flange, or a ball. In addition, the retention recesses 263a-b and the retention protrusions 264a-b can be included in any suitable quantity and in any suitable location or pattern.

In one aspect, ends of the retention protrusions 264a-b can terminate within the retention recesses 263a-b (e.g., within the lower portion 262 of the hitch ball 207). In other words, the retention protrusions 264a-b do not extend all the way through the hitch ball 207 (e.g., through the lower portion 262). In a particular aspect, one or more of the retention recesses 263a-b can be blind openings or holes (e.g., openings or holes that do not extend all the way through the lower portion 262 of the hitch ball 207). Thus, one or more of the retention recesses 263a-b can be blind openings or through openings and the retention protrusions 264a-b may not extend all the way through the hitch ball 207.

Although the retention recesses 263a-b have been shown and described as being associated with the hitch ball 207 and the retention protrusions 264a-b have been shown and described as being associated with the body portion 260, it should be recognized that retention recesses and retention protrusions can be associated with a hitch ball and/or a body portion, in any suitable arrangement or combination, as desired. For example, retention recesses can be associated with a body portion, and retention protrusions can be associated with a hitch ball. In another example, retention recesses and retention protrusions can be associated with both a hitch ball and a body portion.

The weight measuring hitch ball assembly 201 can include a hitch mount interface 252 configured to interface with an attachment structure as disclosed herein. For example, the weight measuring hitch ball assembly 201 can be adapted to interface with and be integrated into a variety of different gooseneck hitch systems, as shown in FIGS. 3C-3G. FIGS. 3C-3E illustrate the weight measuring hitch ball assembly 201 incorporated into an above-bed gooseneck hitch system 202 where the body portion 260 interfaces with an attachment structure 217. FIG. 3F illustrates the weight measuring hitch ball assembly 201 incorporated into an above-bed gooseneck hitch system 202′ where the body portion 260 interfaces with an attachment structure 217′. FIG. 3G illustrates the weight measuring hitch ball assembly 201 incorporated into an above-bed gooseneck hitch system 202″ where the body portion 260 interfaces with an attachment structure 217″. Although above-bed attachment structures are shown in these examples, it should be recognized that the assembly 201 can be adapted to interface with and be integrated into a below-bed gooseneck hitch system.

In one aspect, the hitch mount interface 252 can be at least partially defined by the body portion 260. In this case, the body portion 260 can be configured to interface directly with an above-bed attachment structure 217, 217′, 217″ as shown in FIGS. 3C-3G. In another aspect, the hitch mount interface 252 can comprise one or more coupling features operable to facilitate securing the weight measuring hitch ball assembly 201 to a given above-bed attachment structure 217, 217′, 217″ as shown in FIGS. 3C-3G. Such a coupling feature can be or include any suitable coupling configuration known in the art, such as a threaded coupling feature (e.g., external threads or internal threads), a shaft, a rod, a hole, a recess, a groove, a pin, or any other feature suitable for coupling the assembly 201 to an attachment structure and/or a tow vehicle and maintaining structural integrity during towing. In one aspect, a coupling feature as disclosed herein can be associated with the body portion 260 and/or be at least partially defined by the body portion (e.g., an opening, a hole, a stud, etc.). For example, the hitch mount interface 252 can include coupling features 255 (e.g., openings, holes (threaded or otherwise), or other suitable features) to facilitate securing the weight measuring hitch ball assembly 201 to a given above-bed attachment structure 217, 217′, 217″.

In the example illustrated in FIGS. 3C-3E, the attachment structure 217 can include an upper portion 218 and a lower mounting plate 219. The hitch mount interface 252 can be located at any suitable location or position on or about the body portion 260. In one aspect, the hitch mount interface 252 can be located at an upper end 266a of the body portion 260, a lower end 266b of the body portion 260, or both, or anywhere in between. For example, the hitch mount interface 252 can comprise at least one of a planar interface surface 253a-b or a curved interface surface 254, as shown in FIGS. 3A and 3B. Such interface surfaces can form or be a part of any suitable shape or geometry. For example, the planar interface surfaces 253a-c can at least partially define a rectangular profile (e.g., a rectangular cuboid shape) and the curved interface surface 254 can at least partially define a circular profile (e.g., a cylindrical shape). The curved interface surface 254 can be configured to fit within an opening in the upper portion 218 and interface with the upper portion 218. The planar interface surface 253a can interface with an underside of the upper portion 218. The top or upper coupling features 255 can be operable to receive a threaded fastener 256 (FIG. 3C) to couple the hitch ball assembly 201 to the upper portion 218. A bottom or lower coupling feature (e.g., an opening or hole (threaded or otherwise) obscured from view) can be operable to receive a threaded fastener 257 (FIGS. 3D and 3F) to couple the hitch ball assembly 201 to the lower mounting plate 219. The lower mounting plate 219 can be coupled to the upper portion 218 with a threaded fastener 258 (FIGS. 3C-3E). The attachment structure 217 can also include a mounting bracket 259, tab, or other such structure operable to couple the attachment structure 217 to a tow vehicle (e.g., a bed of the tow vehicle).

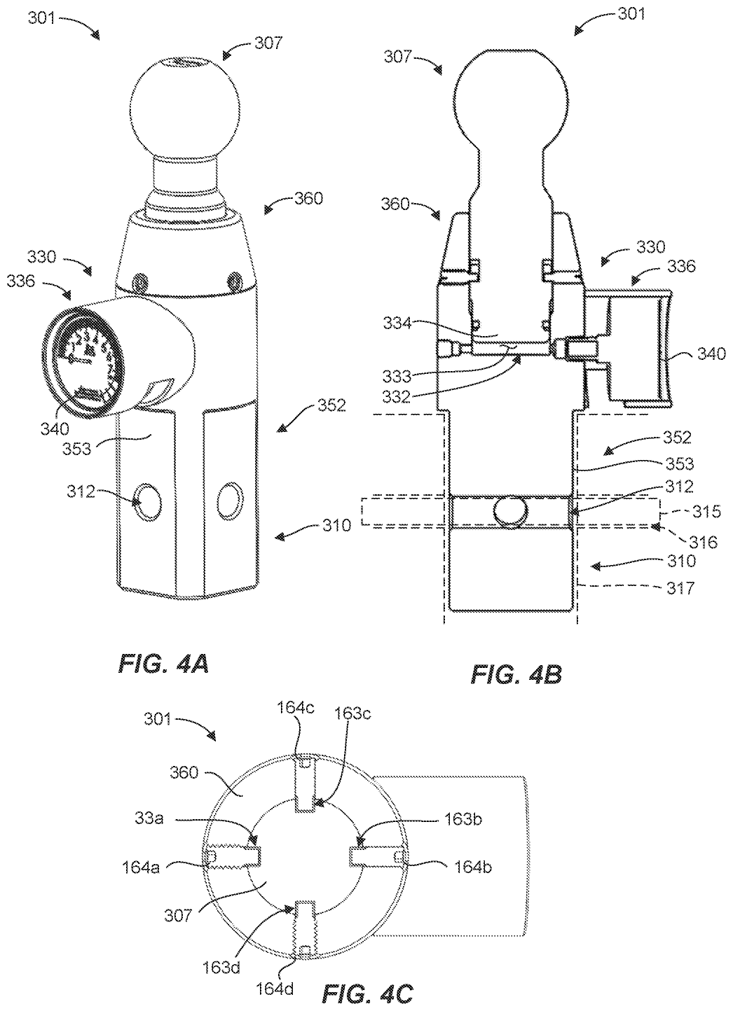

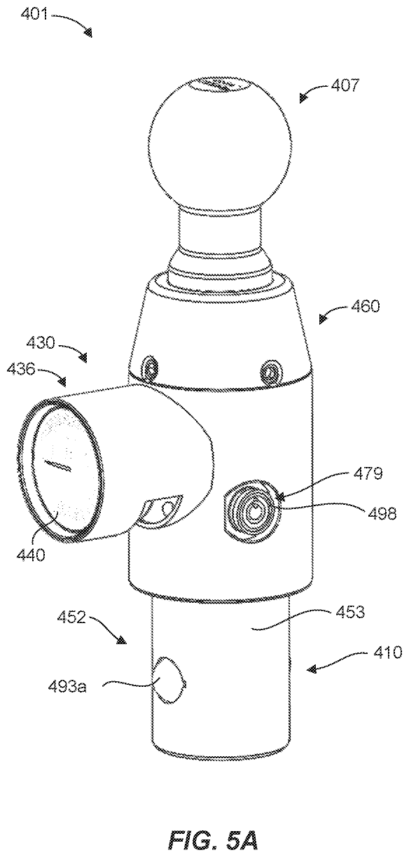

FIGS. 4A-4C illustrate a weight measuring hitch ball assembly 301 in accordance with an example of the present disclosure. As with the weight measuring hitch ball assembly 201 of FIGS. 3A and 3B discussed above, in this example, the weight measuring hitch ball assembly 301 of FIGS. 4A-4C includes a load measurement device 330 with a reservoir 332 having a fluid 333 and a piston 334 integrated with a hitch ball 307 disposed in the reservoir 332, as shown in FIG. 4B. In this case, a pressure sensor 336, or gauge, and associated display 340 are located on, or mounted to, a body portion 360. Although a particular load measurement device configuration is illustrated, it should be recognized that any suitable load measurement device disclosed herein can be utilized.

The weight measuring hitch ball assembly 301 can include a hitch mount interface 352 configured to interface with an attachment structure as disclosed herein. In the illustrated example, the weight measuring hitch ball assembly 301 can include a hitch portion 310 extending downward from the body portion 360 below the hitch ball 307. The hitch portion 310 can be permanently attached (e.g., integrally formed) with the body portion 360 or removably coupled to the body portion 360. The hitch mount interface 352 can be at least partially defined by the hitch portion 310. Thus, the hitch portion 310 can be configured to interface with an attachment structure as disclosed herein. In this example, an attachment structure 317 can comprise a goose ball receiver socket mounted on (e.g., below-bed) or otherwise associated with a tow vehicle. Thus, the hitch portion 310 can be adapted to interface with an attachment structure 317 configured as a goose ball receiver socket mounted on (e.g., below-bed) or otherwise associated with a tow vehicle. In particular, the hitch portion 310 comprises a rectangular cuboid configuration, which may be sized and configured to fit within a given below-bed attachment structure. A typical cross-sectional size for the hitch portion 310 may be a 2-inch by 2-inch square.

The hitch mount interface 352 can be or include any suitable geometry or configuration to facilitate interfacing, coupling, joining, mating, etc. with a given attachment structure. For example, the hitch mount interface 352 can comprise at least one of a planar interface surface 353 or a curved interface surface. In some examples, the planar interface surface 353 can at least partially define a rectangular profile. In some examples, a curved interface surface can at least partially define a circular profile.

In one aspect, the hitch mount interface 352 can comprise one or more coupling features 312 operable to facilitate securing the weight measuring hitch ball assembly 301 to the attachment structure 317. Such a coupling feature can be or include any suitable coupling configuration known in the art, such as a threaded coupling feature (e.g., external threads or internal threads), a shaft, a rod, a hole, a recess, a groove, a pin, or any other feature suitable for coupling the assembly 301 to the attachment structure 317 and/or a tow vehicle and maintaining structural integrity during towing. In one aspect, the coupling feature 312 can be associated with the hitch portion 310. In one example, the hitch portion 310 can include coupling features 312 (e.g., openings, holes, or other suitable features) to facilitate securing the weight measuring hitch ball assembly 301 to the attachment structure 317. In a particular example, the opening 312 can be operable to receive a pin, rod, shaft, or threaded fastener 315, which can extend through the openings 312 of the hitch portion 310 and through similar openings or holes 316 of the attachment structure 317 aligned with the opening 312.

The top cross-sectional view of FIG. 4C further illustrates an arrangement of retention recesses 363a-d and the retention protrusions 364a-d that serve to secure the hitch ball 307 to the body portion 360. In this case, four retention protrusions 364a-d extend into four respective retention recesses 363a-d, which are equally spaced about the circumference of the body portion 360 and the hitch ball 307, although any suitable configuration may be utilized.

FIGS. 5A-5C illustrate a weight measuring hitch ball assembly 401 in accordance with an example of the present disclosure. As with other weight measuring hitch ball assemblies discussed above, in this example, the weight measuring hitch ball assembly 401 includes a load measurement device 430 with a reservoir 432 having a fluid 433 and a piston 434 integrated with a hitch ball 407 disposed in the reservoir 432, as shown in FIGS. 5A and 5B. In this case, a pressure sensor 436, or gauge, and associated display 440 are located on, or mounted to, a body portion 460. Although a particular load measurement device configuration is illustrated, it should be recognized that any suitable load measurement device disclosed herein can be utilized.

The weight measuring hitch ball assembly 401 can include a hitch mount interface 452 configured to interface with an attachment structure as disclosed herein. In the illustrated example, the weight measuring hitch ball assembly 401 can include a hitch portion 410 extending downward from the body portion 460 below the hitch ball 407. The hitch portion 410 can be permanently attached (e.g., integrally formed) with the body portion 460 or removably coupled to the body portion 460. The hitch mount interface 452 can be at least partially defined by the hitch portion 410. Thus, the hitch portion 410 can be configured to interface with an attachment structure as disclosed herein. In this example, an attachment structure 417 can comprise a goose ball receiver socket mounted on (e.g., below-bed) or otherwise associated with a tow vehicle. Thus, the hitch portion 310 can be adapted to interface with an attachment structure 317 configured as a goose ball receiver socket mounted on (e.g., below-bed) or otherwise associated with a tow vehicle. In this case, the hitch portion 410 comprises a cylindrical configuration (e.g., a circular cross-section), which may be sized and configured to fit within a given below-bed attachment structure. Such a configuration is typically associated with OEM-type goose ball hitch attachment structures.

The hitch mount interface 452 can be or include any suitable geometry or configuration to facilitate interfacing, coupling, joining, mating, etc. with a given attachment structure. For example, the hitch mount interface 452 can comprise at least one of a planar interface surface or a curved interface surface 453. In some examples, a planar interface surface can at least partially define a rectangular profile. In some examples, the curved interface surface 453 can at least partially define a circular profile (e.g., a cylindrical shape).

In one aspect, the hitch mount interface 452 can comprise a coupling feature operable to facilitate securing the weight measuring hitch ball assembly 401 to the attachment structure 417. OEM-type goose ball hitch attachment structures typically utilize a radiused or semicircular-shaped groove 416 configured to receive and interface with one or more balls 493a-b extending laterally from the hitch portion 410, as shown in FIG. 5B. Accordingly, in one aspect, the hitch mount interface 452 coupling feature can comprise a securing mechanism 492 operable to secure the assembly 401 to a suitable attachment structure 417. For example, the coupling feature or securing mechanism 492 can include a movable ball 493a-b operable to extend into the groove 416 in the attachment feature 417 to secure the weight measuring hitch ball assembly 401 to the attachment feature 417 and to retract from the groove 416 to facilitate removal of the weight measuring hitch ball assembly 401 from the attachment feature 417. The balls 493a-b can be laterally movable within respective openings 478a-b in the hitch portion 410. The ball 493 can be operable to engage the attachment structure 417 (e.g., via a radiused or semicircular-shaped groove 416). The securing mechanism 492 can also include a cam 494 operable to maintain the balls 493a-b laterally outward in a secured position (FIG. 5B) or allow movement of the ball 493 laterally inward in a release position (FIG. 5C). The cam 494 can include a wide portion 494a configured to contact the balls 493a-b and maintain the balls in the outward, secured position. The cam 494 can also include a narrow portion 494b that is configured to allow the balls to retract inward in the release position. The secured and release positions can be achieved by a 90-degree rotation of the cam 494.

In one aspect, the securing mechanism 492 can include a shaft 495 coupled to and extending from the cam 494, a gear 496 associated with the shaft 495, and a gear 497 operably coupled to the gear 496. In one aspect, the gears 496, 497 can be located in, and supported by, a body portion 460 of the weight measuring hitch ball assembly 401. The gear 497 can be associated with a user interface 498 (FIG. 5A) to operate the cam 494. At least one of the gear 496 or the gear 497 can be rotatable to operate the cam 494. For example, as shown in FIGS. 5B and 5C, the gear 496 can be a spur gear rotatable about a longitudinal axis 499a of the shaft 495 and the gear 497 can be a worm gear rotatable about an axis 499b oriented non-parallel (e.g., perpendicular) to the longitudinal axis 499a of the shaft 495. In another example, the gear 496 can be a pinion gear rotatable about the longitudinal axis 499a of the shaft 495, and the gear 497 can be a rack gear translatable in a direction non-parallel (e.g., perpendicular) to the longitudinal axis 499a of the shaft 495. In this case, the cam 494 can be actuated by a press type (e.g., button) user interface.

In one aspect, the securing mechanism 492 can include a locking mechanism 479 (e.g., a lock core) operable to alternately lock and release the gear 497 when the cam 494 is in the secured position to prevent unwanted release of the weight measuring hitch ball assembly 401 from the attachment structure. In one aspect, the user interface 498 can comprise an engagement feature for a key to the locking mechanism 479.

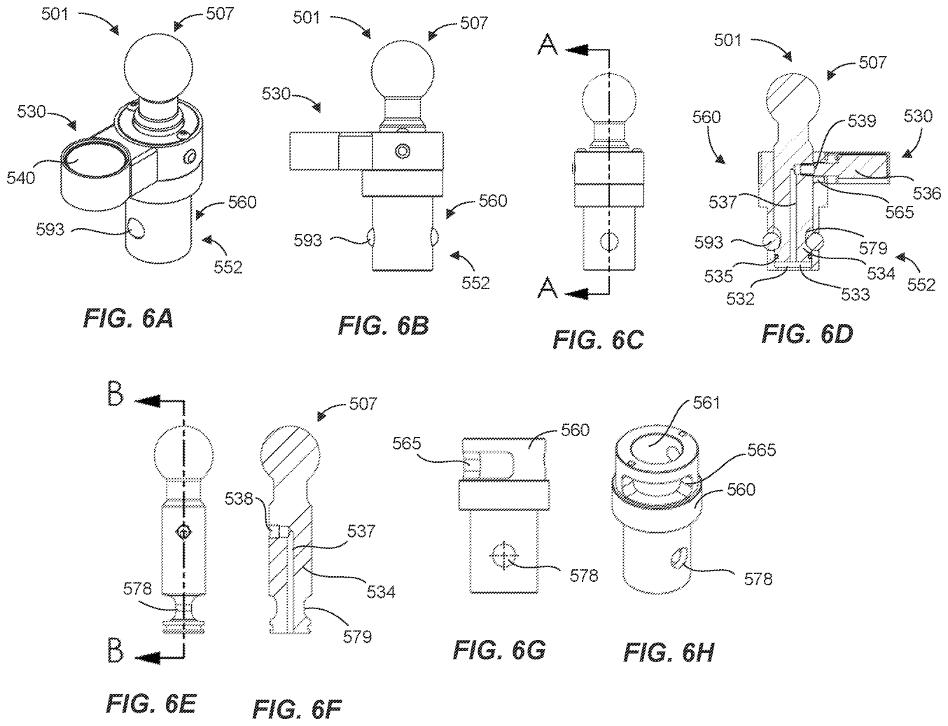

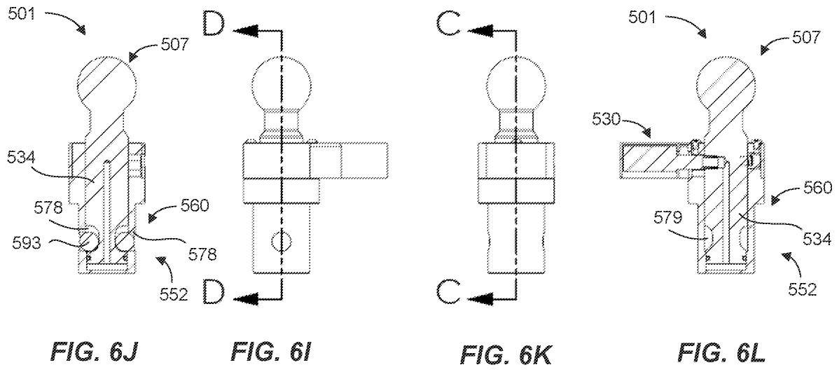

FIGS. 6A-6L illustrate a weight measuring hitch ball assembly 501 in accordance with an example of the present disclosure. As with other weight measuring hitch ball assemblies discussed above, in this example, the weight measuring hitch ball assembly 501 includes a load measurement device 530 with a reservoir 532 having a fluid 533 and a piston 534 integrated with a hitch ball 507 disposed in the reservoir 532, as shown in FIG. 6D. In this case, a pressure sensor 536, or gauge, and associated display 540 are located on, or mounted to, a body portion 560. Although a particular load measurement device configuration is illustrated, it should be recognized that any suitable load measurement device disclosed herein can be utilized.

The weight measuring hitch ball assembly 501 has a vertical profile with a moment arm from the hitch mount interface 552 to the hitch ball 507 that allows the weight measuring hitch ball assembly 501 to withstand forces exerted on the hitch ball 507 and body portion 560. In some embodiments, this vertical profile can be lower than that of other embodiments or other hitch ball assemblies (e.g. low profile and/or short moment arm) and as such, can allow exertion of a particularly large amount of force thereon (e.g. an amount greater than that of other hitch ball assemblies with a higher profile or longer moment arm).

In this example, the hitch mount interface 552 comprises portions of the hitch ball 507 and the body portion 560. Specifically, the piston 534 of the hitch ball comprises a first pair of grooves 578 and a second pair of grooves 579 running substantially perpendicular to the first pair of grooves 578 (in some embodiments, the pairs of grooves can substantially create a single groove circumscribing the circumference of the piston 534). The first and second pairs of grooves 578, 579 accommodate balls 593 that are disposed adjacent to opening 578 in the body portion 560 of the weight measuring hitch ball assembly 501. The first pair of grooves 578 run substantially parallel, and when the first pair of grooves 578 are aligned with the openings 578, the first pair of grooves 578 provide sufficient clearance such that the balls 593 are not forced to protrude out of the openings 578 of the body portion (see FIGS. 6J). With the first pair of grooves 578 in this position, the weight measuring hitch ball assembly 501 can be inserted into and removed from a hitch receiver.

When the hitch ball 507 is rotated relative to the body portion 560 such that the second pair of grooves 579 are aligned with the openings 578, the second pair of grooves 579 are sized such that the second pair of grooves 579 force the balls 593 to protrude from the openings 578 (see FIG. 6D). In this position, the weight measuring hitch ball assembly 501 is locked within a hitch receiver.

In this example, a user can rotate the hitch ball 507 relative to the body portion 560 via the load measurement device 530. The load measurement device 530 can interface with the body portion near a top of the body portion 560. For example, the body portion 560 can provide an annular slot 565 that extends approximately 90 degrees around the body portion 560. The load measurement device 540 can have an attachment protrusion 539 that extends into the annular slot 560 and connects to the hitch ball 507. When the user rotates the load measurement device 530, the load measurement device 530 rotates the hitch ball relative to the body portion 560. The relative rotation is limited by the length of the annular slot 565. The rotation of the hitch ball 507 alternates which of the first pair of grooves 578 and the second pair of grooves 579 is in alignment with the openings 579 to either force the balls 593 to protrude from the openings 579 or to allow the balls 593 to remain within the body portion 560.

The interface between the balls 593, the openings 578, and the first and second pair of grooves 593 also facilitate retaining the hitch ball 507 within the slot 561 of the body portion 560 of the weight measuring hitch ball assembly 501 while allowing sufficient vertical movement of the hitch ball within the slot 561 to obtain a weight measurement via the load measurement device 530. For example, as shown in FIGS. 6D and 6J, the first and second pairs of grooves 578, 579 can be configured with a height that is greater than the width of the balls 593. Thus, the balls 593 can retain the piston 534 of the hitch ball 507 in the slot 561 of the body portion 560 while also allowing sufficient vertical movement of the piston 534 to facilitate operation of the load management device 530.

To further aid in keeping the low profile of the weight measuring hitch ball assembly 501, the load management device comprises a reservoir 532 with fluid 533 that is disposed within the body portion 560 below the piston 534. An O-ring or gasket 535 can be provided to seal the fluid 533 within the reservoir 532. The reservoir 532 is connected with a conduit 537 that extends upwards from the reservoir 532 into the piston 534 terminating at an outlet 538 into which the pressure sensor 536 can be inserted. When a downward force is applied on the hitch ball 507, the fluid 533 in the reservoir 532 is forced upwards through the conduit 537, and a pressure can be detected by the pressure sensor 536 that correlates with a weight of the force on the hitch ball 507.

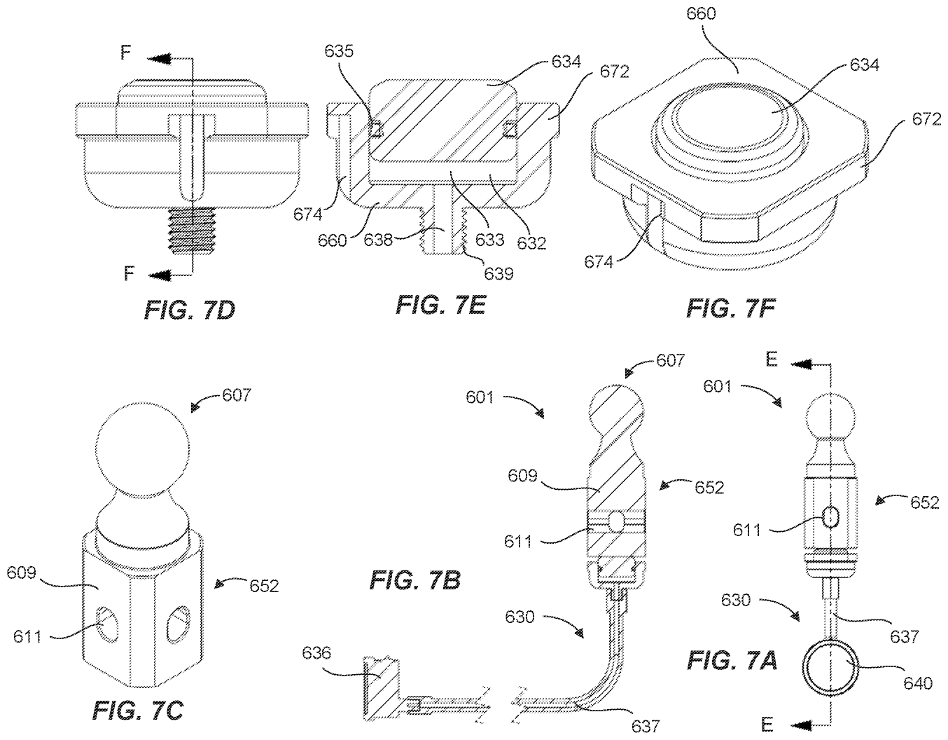

FIGS. 7A-7F illustrate a weight measuring hitch ball assembly 601 in accordance with an example of the present disclosure. As with other weight measuring hitch ball assemblies discussed above, in this example, the weight measuring hitch ball assembly 601 includes a load measurement device 630 with a reservoir 632 having a fluid 633 and a piston 634 disposed in the reservoir 632, as shown in FIGS. 7A, 7B, and 7E. In this case, a pressure sensor 636, or gauge, and associated display 640 are connected to the body portion 660 via a conduit 630. Although a particular load measurement device configuration is illustrated, it should be recognized that any suitable load measurement device disclosed herein can be utilized.

The weight measuring hitch ball assembly 601 is a low profile weight measuring hitch ball assembly. Due to the low profile of the weight measuring hitch ball assembly 601, the weight measuring hitch ball assembly 601 can withstand a high degree of force exerted on the hitch ball 607 due to a decreased moment arm from the hitch mount interface 652 to the hitch ball 607.

The weight measuring hitch ball assembly 601 comprises a hitch ball 607 that has a hitch mount interface 652 formed by a lower portion 609 of the hitch ball 607. The lower portion 609 comprises one or more through holes 611 extending through the lower portion 609. The through holes 611 are configured to receive a connecting pin or shaft from a hitch receiver to lock or secure the hitch ball into the hitch receiver. The through holes 611 are formed to have an elongated profile. Thus, the through holes 611 provide vertical clearance to allow the hitch ball 607 to move vertically even when the connecting pin or shaft extends through one of the through holes 611.

The weight measuring hitch ball assembly 601 comprises a load measurement device 630. The load measurement device 630 comprises a body portion 660 having a reservoir 632 with fluid 633 therein. A piston 634 is disposed in the body portion 660 and in the reservoir 632. The piston 634 comprises an O-ring or gasket 635 that seals the reservoir 632.

The body portion 660 comprises a flange 672 along a top side of the body portion 660. The flange 672 can interface with a hitch receiver to transfer weight applied to the body portion 660 to the hitch receiver and thereby to the frame of a vehicle. Specifically, the piston 634 is configured to receive and support the hitch ball 670. Thus, the weight applied to the hitch ball 607 is transferred to the piston 634 which is supported by the body portion 660. The weight is thus transferred from the body portion 660 via the flange 672 to the hitch receiver and vehicle. As mentioned above, the elongated profile of the through hole 611 ensures that the piston 634 bears the weight transferred by the hitch ball 607 due to the vertical motion allowed by the elongated profile. This allows the hitch ball 617 to move vertically to facilitate any fluid loss or variation in the fluid 633 of the reservoir 632.

The reservoir 632 is connected to an opening 638 on a lower side of the body portion 660. The opening 638 extends through a coupling 639, which can be a male threaded end, to facilitate attachment of a conduit 637. The conduit can connect the fluid 633 of the reservoir 632 to the pressure sensor 636. The pressure sensor 636 and display 640 can be mounted on the vehicle at any desired location such as in a wheel well, at a rear bumper of the vehicle, or adjacent to the hitch receiver, as desired.

In some examples, the body portion 660 can comprise a drain 674. The drain 674 can be disposed in a side of the body portion 660. In this example, the drain 674 is formed as a groove or indentation along the side of the body portion and extending partially into the flange 672. The drain allows a passage for liquids such as water to flow underneath the weight measuring hitch ball assembly 701 to prevent damage or corrosion to the weight measuring hitch ball assembly 701.

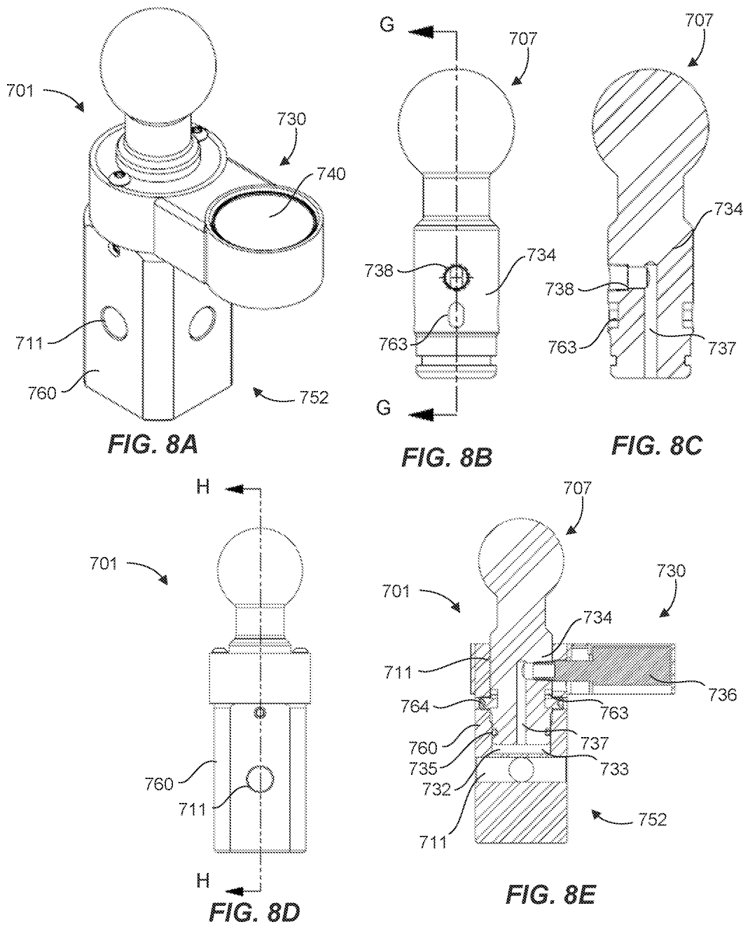

FIGS. 8A-8E illustrate a weight measuring hitch ball assembly 701 in accordance with an example embodiment. As with other weight measuring hitch ball assemblies discussed above, in this example, the weight measuring hitch ball assembly 701 includes a load measurement device 730 with a reservoir 732 having a fluid 733 and a piston 734 integrated with a hitch ball 707 disposed in the reservoir 732, as shown in FIG. 8E. In this case, a pressure sensor 736, or gauge, and associated display 740 are located on, or mounted to, a body portion 760. Although a particular load measurement device configuration is illustrated, it should be recognized that any suitable load measurement device disclosed herein can be utilized.

The weight measuring hitch ball assembly 701 is a low profile weight measuring hitch ball assembly. Due to the low profile of the weight measuring hitch ball assembly 701, the weight measuring hitch ball assembly 701 can withstand a high degree of forces exerted on the hitch ball 707 and body portion 760 due to a decreased moment arm from the hitch mount interface 752 to the hitch ball 707.

In this example, the hitch mount interface 752 is formed as part of the body portion 760. The body portion 760 can comprise through holes 711 that are configured to receive a shaft or pin that locks the body portion 760 into a hitch receiver.

The body portion can further comprise a slot 711 into which the hitch ball 707 is inserted. The hitch ball 707 is retained in the slot via protrusions 764 that are inserted into corresponding recesses 763 of the hitch ball 707. In this example, the protrusions 764 can be set screws, though other protrusions can also be used. The recesses 736 are formed to provide clearance such that the hitch ball 707 can move vertically within the slot 711 to accommodate any change in the fluid 733 of the reservoir 732.

The load measurement device 730 can interface with the body portion 760 near a top of the body portion 760. To further aid in keeping the low profile of the weight measuring hitch ball assembly 701, the load management device 730 comprises a reservoir 732 with fluid 733 that is disposed within the body portion 760 below the piston 734. An O-ring or gasket 735 can be provided to seal the fluid 733 within the reservoir 732. The reservoir 732 is connected with a conduit 737 that extends upwards from the reservoir 732 into the piston 734 terminating at an outlet 738 into which the pressure sensor 736 can be inserted. When a downward force is applied on the hitch ball 707, the fluid 733 in the reservoir 732 is forced upwards through the conduit 737, and a pressure can be detected by the pressure sensor 736 that correlates with a weight of the force on the hitch ball 707.

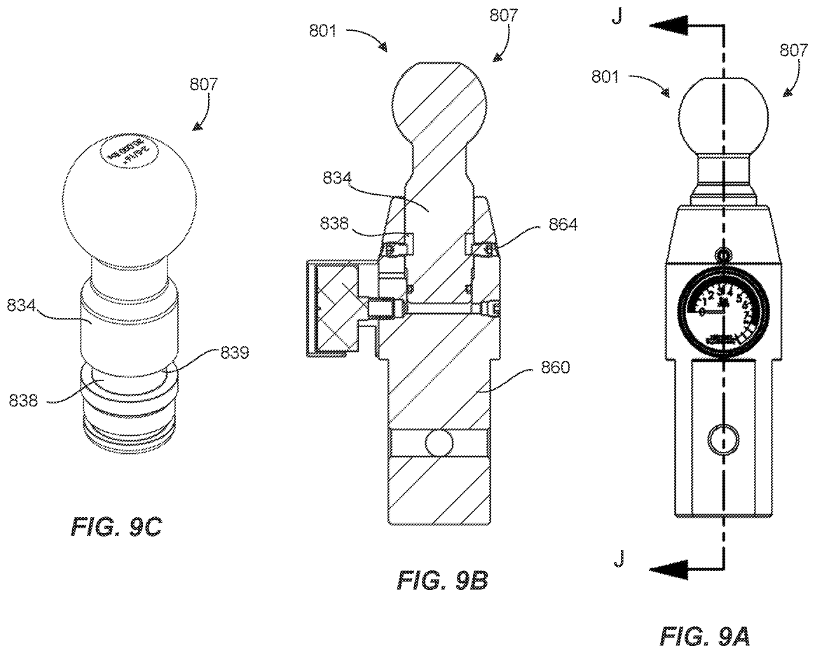

FIGS. 9A-9C illustrate a weight measuring hitch ball assembly 801 in accordance with an example of the present disclosure. The hitch ball assembly 801 is substantially similar to the weight measuring hitch ball assembly 301 shown in FIGS. 4A-4C, and thus a full description of similar parts will be omitted for the sake of brevity.

The weight measuring hitch ball assembly 801 comprises a hitch ball 807 that is inserted into a body portion 860. The hitch ball 807 varies from the hitch ball 307 in that the piston 834 of the hitch ball 807 comprises an annular groove 838. The annular groove 838 is operable to receive protrusions 864 that extend into the annular groove 838 to retain the hitch ball 807 within the body portion 860. The protrusions 864 in this examples are shown as set screws. However, other protrusions (e.g. elongated protrusions) can also be compatible with the annular groove 838. For example, pins, such as roll pins, bolts, rods, or dowels, etc. can be inserted through the body portion 860 and protrude into the annular groove 838, along a portion of a length of the elongated protrusion, such that they are tangent with an inner surface 839 of the annular groove 838. In some examples, instead of a full annular groove (e.g. circumscribing), the groove may be formed into a single or multiple sides to accommodate the roll pins or dowels as protrusions. In some embodiments, the grooves may be on opposing sides. In further embodiments, the elongated protrusions may engage the grove(s) in an orientation that is substantially parallel to one another. Other variations can also be implemented.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein. 1-31. (canceled)

32. A weight measuring hitch ball assembly, comprising:
a hitch ball having a ball and a lower portion, the hitch ball having an outlet formed therein configured to receive a portion of a load measurement device;
a body portion defining a hitch ball opening that slidably receives the lower portion of the hitch ball;
a load measurement device configured to determine a magnitude of a force acting on the hitch ball; and
a hitch mount interface configured to interface with an attachment structure that facilitates coupling the weight measuring hitch ball assembly to a tow vehicle.

33. The weight measuring hitch ball assembly of claim 32, wherein a conduit is defined within the hitch ball from an interface between the hitch ball and the body portion to the outlet and is configured to facilitate communication of the downward force on the hitch ball to the load measurement device.

34. The weight measuring hitch ball assembly of claim 33, wherein the load measurement device comprises:
a pressure sensor configured to measure a downward force on the hitch ball at an interface between the hitch ball and the body portion;
a display disposed at the outlet and configured to display a magnitude of the downward force; and
wherein the conduit defined in the hitch ball facilitates communication of the downward force at the interface to the display.

35. The weight measuring hitch ball assembly of claim 32, wherein the lower portion of the hitch ball forms a piston; and
wherein the load measurement device comprises:
a fluid reservoir defined within the body portion and configured to contain a fluid;
a pressure sensor coupled to the hitch ball at the outlet defined in the hitch ball; and
a conduit defined in the hitch ball configured to be in fluid communication with the fluid reservoir and the outlet.

36. The weight measuring hitch ball assembly of claim 32, wherein the load measurement device is operably coupled to the hitch ball through an opening formed in the body portion.

37. The weight measuring hitch ball assembly of claim 36, wherein the opening formed in the body portion is an annular slot.

38. The weight measuring hitch ball assembly of claim 32, wherein the hitch ball comprises one or more retention recesses formed therein;
wherein the hitch ball is configured to be coupled to the body portion by one or more retention protrusions configured to secure the hitch ball to the body portion.

39. The weight measuring hitch ball assembly of claim 38, wherein the one or more retention protrusions are sized relative to the one or more retention recesses to leave a clearance between the one or more retention protrusions and the one or more retention recesses equal to or greater than a slidable range of motion of the hitch ball within the body portion in response to a downward force applied to the hitch ball.

40. The weight measuring hitch ball assembly of claim 39, wherein the one or more retention protrusions are one or more of set screws, pins, such as roll pins, bolts, rods, or dowels.

41. The weight measuring hitch ball assembly of claim 39, wherein the one or more retention recess comprises an annular groove formed around at least a portion of a circumference of the hitch ball.

42. The weight measuring hitch ball assembly of claim 32, wherein the hitch mount interface comprises a coupling feature operable to facilitate securing the weight measuring hitch ball assembly to the attachment structure.

43. The weight measuring hitch ball assembly of claim Error! Reference source not found.2, wherein the coupling feature is associated with the body portion.

44. The weight measuring hitch ball assembly of claim 43, wherein the coupling feature is at least partially defined by the body portion.

45. The weight measuring hitch ball assembly of claim 44, wherein the coupling feature extends downward from the body portion below the hitch ball.

46. The weight measuring hitch ball assembly of claim Error! Reference source not found.2, wherein the coupling feature comprises a threaded coupling feature.

47. The weight measuring hitch ball assembly of claim Error! Reference source not found.2, wherein the coupling feature comprises an opening operable to receive a pin or a rod.

48. The weight measuring hitch ball assembly of claim Error! Reference source not found.2, wherein the coupling feature comprises a movable ball operable to extend into a groove in the attachment structure to secure the weight measuring hitch ball assembly to the attachment structure and to retract from the groove to facilitate removal of the weight measuring hitch ball assembly from the attachment structure.

49. The weight measuring hitch ball assembly of claim Error! Reference source not found.8, wherein the lower portion of the hitch ball comprises one or more first grooves and one or more second grooves positioned circumferentially around the lower portion of the hitch ball and configured to engage with the moveable ball;

50. The weight measuring hitch ball assembly of claim Error! Reference source not found.9, wherein the hitch ball is moveable to cause either the first grooves or the second grooves to engage with the moveable ball.

51. The weight measuring hitch ball assembly of claim 50, wherein the first grooves are deeper than the second grooves such that, when the hitch ball is moved to engage the first grooves with the moveable ball, the moveable ball is in a retracted state away from the groove in the attachment structure, and, when the hitch ball is moved to engage the second grooves with the moveable ball, the moveable ball is caused to extend into the groove in the attachment structure.

52. A weight measuring hitch ball system, comprising:
the weight measuring hitch ball assembly of claim 32; and
the attachment structure.

53. A method of measuring weight of a trailer supported by a tow vehicle, comprising:
engaging a coupling device of a trailer with the weight measuring hitch ball assembly of claim 32, the weight measuring hitch ball assembly being operably coupled to the tow vehicle.
